(19) United States
(12) Patent Application Publication
(10) Pub. No.: US 2026/0299555 A1
(43) Pub. Date: Oct. 1, 2026

(54) NUMERIC VALUE CONTROL SYSTEM, NUMERIC VALUE CONTROL DEVICE, INDUSTRIAL DEVICE, AND COMPUTER PROGRAM

(71) Applicant: FANUC CORPORATION, Yamanashi (JP)

(72) Inventor: Takumi MUROFUSHI, Yamanashi (JP)

(73) Assignee: FANUC CORPORATION, Yamanashi (JP)

(21) Appl. No.: 18/880,514

(22) PCT Filed: Aug. 26, 2022
(86) PCT No.: PCT/JP2022/032289

§ 371 Date: Dec. 31, 2024

(51) Int. Cl. G05B 19/4155; B25J 9/00

(52) U.S. Cl. CPC G05B 19/4155; B25J 9/0096; G05B 2219/39001

(57) ABSTRACT

Provided is a system in which a robot and a work machine operate together, wherein faults that can occur when a custom macro variable is used in a processing program are prevented. The present invention relates to a numeric value control system, the numeric value control system comprising: a program-editing unit that does not use the variables included in the processing programs in the numeric value control device or included in a robot program in the robot control device if said variables are used in a correlation different from that in the variable list information, and moreover does not use the variables included in the variable list information if said variables are used in processing programs that are not present in the variable list information.

### TECHNICAL FIELD

The present invention relates to a numerical control system, a numerical control device, an industrial device, and a computer program.

### BACKGROUND ART

In order to advance the automation of a machining site, an automation system for interlocking a machine tool which machines a workpiece with a robot which mounts and dismounts the workpiece has been desired. For example, a technique has been known which enables the selection of an operation program of a robot and setting of the operation program, in accordance with an instruction by a user from a numerical control device of a machine tool (for example, refer to Patent Document 1).

In such a system in which the robot and the machine tool interlock with each other, the robot control device controlling the robot causes the robot and the machine tool to interlock, by reading and writing custom macro variables of the machine tool. For example, the robot control device turns ON an operation request through custom macro variables of the machine tool, and acquires an operating state by reading out the custom macro variable of the machine tool. Then, the robot control device, in the case of the operating state being operation completion, performs processing to turn OFF the operation request and advance to the next sequence (for example, refer to Patent Document 2).

### CITATION LIST

### Patent Document

Patent Document 1: Japanese Unexamined Patent Application, Publication No. 2018-195055

Patent Document 2: PCT International Publication No. WO2022/097719

### DISCLOSURE OF THE INVENTION

### Problems to be Solved by the Invention

The custom macro variable is used in the calculation of machining conditions and the like of the machining program. The custom macro variable can change the processing of the machining program, and change the operation of the machine tool, in accordance it the value of a variable when used in a conditional expression. In a system in which a robot and a machine tool are interlocked with each other, when causing the robot and the machine tool to interlock by the robot reading/writing the custom macro variable, the user prepares a custom macro variable for interlocking with the robot.

In the case of the robot and the machine tool interlocking with each other using the custom macro variable of the machine tool, if this variable is used by the machining program, the robot will read and write a variable which is in use by the machining program. In the case of the robot writing on a variable in use by the machining program, if the variable is being used in a conditional expression in the machining program, the robot will change the value of the variable. For this reason, there is a possibility of becoming a value different from the conditional expression originally intended by the user. As a result thereof, there is a possibility of unintended processing of the machining program being executed, and machining failure, breakage of the tool or machine, or the like occurring.

On the other hand, in the case of the robot reading a variable in use by the machining program, if the variable is being used in calculations in the machining program, the robot will read a value that changes in this calculation. There is a possibility of the robot performing a determination not intended by the user, such as machining completion by the machine tool, opening of the door of the machine tool, etc., based on the value of the read variable. As a result thereof, for example, there is a possibility of the robot determining that the machining has completed in the middle of machining, and trying to enter into the machine tool in order to retrieve a workpiece, and thus the machine tool and the robot colliding with each other.

In this way, when a variable that is in use by a machining program is duplicately used in different applications, there is a possibility of causing various malfunctions. Therefore, in systems in which a robot and a machine tool are interlocked with each other, a numerical control system, a numerical control device, an industrial device and a computer program have been desired which prevent malfunctions which can occur when using a custom macro variable in machining programs.

### Means for Solving the Problems

An aspect of the present disclosure relates to a numerical control system for controlling a robot via a robot control device based on machining programs of a numerical control device, the numerical control system including: a variable list information generator that acquires variables from within all of the machining programs in the numerical control device, and generates variable list information in which the variables and the machining programs are associated; and a program editor that, in a case of a variable of the variables included in the machining program of the numerical control device or the robot program of the robot control device being used in a corresponding relationship different from those in the variable list information, does not use the variable, and, in a case of the variables included in the variable list information being used by a machining program which is not present in the variable list information, does not use the variables.

An aspect of the present disclosure relates to a numerical control system for controlling a robot via a robot control device based on a machining program of a numerical control device, the numerical control system including: a variable list information generator that acquires variables from within all of the machining programs in the numerical control device, and generates variable list information in which the variables and the machining programs are associated; and a variable list information outputter that outputs the variable list information to an output device.

An aspect of the present disclosure relates to a numerical control device for controlling a robot via a robot control device using a machining program, the numerical control device including: a variable list information generator that acquires a variable from within the machining program of the numerical control device or the robot program of the robot control device, and generates variable list information in which the variable and the machining program or the robot program are associated; and a program editor that, in a case of the variable included in the machining program or the robot program being used in a corresponding relationship different from that in the variable list information, does not use the variable, and in a case of the variable included in the variable list information being used by a machining program which is not present in the variable list information, does not use the variable.

An aspect of the present disclosure relates to an industrial device including: a receiver that receives a machining program or a robot program from a numerical control device or a robot control device; a variable list information generator that acquires a variable from within the machining program of the numerical control device or the robot program of the robot control device, and generates variable list information in which the variable and the machining program or the robot program are associated; and a variable list information outputter that outputs the variable list information to an output device.

An aspect of the present disclosure relates to a computer program for causing a computer controlling a robot via a robot control device based on a machining program of a numerical control device to execute: a step of acquiring variables from within all of machining programs in the numerical control device, and generating variable list information in which the variables and the machining programs are associated; a step of, in a case of a variable of the variables included in the machining program of the numerical control device or the robot program of the robot control device being used in a corresponding relationship different from those in the variable list information, not using the variable,; and a step of, in a case of the variables included in the variable list information being used by a machining program which is not present in the variable list information, not using the variables.

### BRIEF DESCRIPTION OF THE DRAWINGS

FIG. 1 is a block diagram showing the configuration of a numerical control system according to the present embodiment;

FIG. 2 is a view showing an example of a machining program according to a first embodiment;

FIG. 3 is a view showing an example of processing for retrieving variables according to the first embodiment;

FIG. 4 is a view showing an example of variable list information according to the first embodiment;

FIG. 5 is a view showing an example of outputting variable list information according to the first embodiment;

FIG. 6 is a view showing an example of displaying a warning message according to the first embodiment;

FIG. 7 is a view showing an example of stopping or inhibiting execution of a machining program according to the first embodiment;

FIG. 8 is a flowchart showing processing of an industrial device according to the first embodiment;

FIG. 9 is a flowchart showing processing of a numerical control device according to the first embodiment in a case of performing editing of the machining program;

FIG. 10 is a flowchart showing processing of a numerical control device according to the first embodiment;

FIG. 11 is a view showing an example of displaying a warning message according to a second embodiment;

FIG. 12 is a view showing an example of stopping or inhibiting execution of a machining program according to the second embodiment;

FIG. 13 is a flowchart showing processing of an industrial device according to the second embodiment;

FIG. 14 is a flowchart showing processing in a numerical control device according to the second embodiment in a case of performing editing or creating of a machining program;

FIG. 15 is a flowchart showing processing of a numerical control device according to the second embodiment;

FIG. 16 is a view showing an example of a machining program and robot program according to a third embodiment;

FIG. 17 is a view showing an example of processing of retrieving variables according to the third embodiment;

FIG. 18 is a view showing an example of variable list information according to the third embodiment;

FIG. 19 is a view showing an example of outputting variable list information according to the third embodiment;

FIG. 20 is a view showing an example of displaying a warning message according to the third embodiment;

FIG. 21 is a view showing an example of stopping or inhibiting execution of a robot program according to the third embodiment;

FIG. 22 is a flowchart showing processing of an industrial device according to the third embodiment;

FIG. 23 is a flowchart showing processing in a robot control device according to the third embodiment in a case of performing editing or creating of a robot program;

FIG. 24 is a flowchart showing processing in a robot control device according to the third embodiment in a case of executing a robot program;

FIG. 25 is a view showing an example of outputting variable list information according to a fourth embodiment;

FIG. 26 is a view showing an example of a machining program and a robot program according to the fourth embodiment; and

FIG. 27 is a flowchart showing processing of an industrial device according to the fourth embodiment.

### PREFERRED MODE FOR CARRYING OUT THE INVENTION

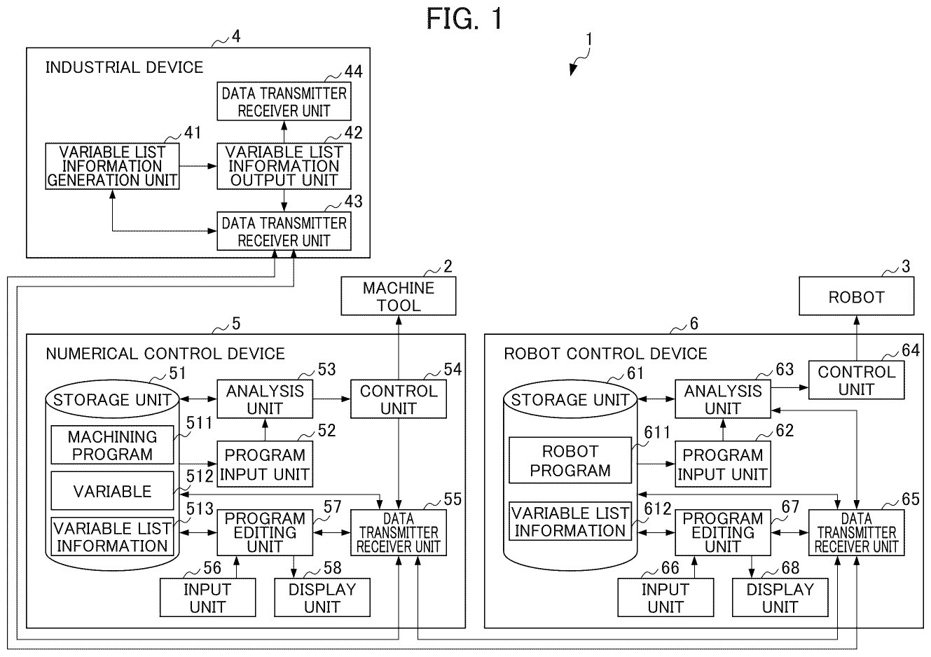

Hereinafter, examples of embodiments according to the present disclosure will be described. FIG. 1 is a functional block diagram of a numerical control system 1 according to the present embodiment.

The numerical control system 1 includes: a machine tool 2 that machines a workpiece (not shown), a robot 3 provided to the machine tool 2 and in the vicinity of the machine tool 2, an industrial device 4 that is communicably connected to the machine tool 2 and the robot 3, a numerical control device (CNC) 5 that controls the operation of the machine tool 2, and a robot control device 6 that controls the operation of the robot 3. The numerical control system 1 controls to interlock the operations of the machine tool 2 and the robot 3 with each other by using the industrial device 4, the numerical control device 5, and the robot control device 6 which are communicably connected to each other.

The machine tool 2 machines a workpiece (not shown) according to machine tool control signals sent from the numerical control device 5. Herein, the machine tool 2, for example, is a lathe, a ball mill, a milling machine, a grinding machine, a laser processing machine, an injection molding machine, and the like; however, it is not limited to these.

The robot 3 operates under the control of the robot control device 6, and performs a predetermined operation on a workpiece to be machined by the machine tool 2, for example.

The robot 3 is, for example, an articulated robot, and a tool for gripping, machining, or inspecting a workpiece is attached to an arm tip portion thereof. Hereinafter, a case where the robot 3 is a six-axis articulated robot will be described; however, it is not limited thereto. In addition, hereinafter, a case of the robot 3 being a six-axis articulated robot will be described: however, the number of axes is not limited thereto.

The industrial device 4 may be provided within a numerical control device 5, or may be provided to a computer device or the like outside of the numerical control device 5. Hereinafter, an example providing the industrial device 4 outside of the numerical control device will be described.

The industrial device 4, numerical control device 5 and robot control deice 6 are each a computer configured by hardware such as an arithmetic processing unit such as a CPU (Central Processing Unit), an auxiliary storage unit such as an HDD (Hard Disk Drive) and/or an SSD (Solid State Drive) storing various computer programs, a main storage unit such as RAM (Random Access Memory) for temporarily storing data necessary for the arithmetic processing unit to execute a computer program, an operation unit such as a keyboard on which an operator performs various operations, and a display unit such as a display for displaying various information to the operator. This industrial device 4, numerical control device 5 and robot control device 6 become able to send and receive various signals with each other by way of the Internet (registered trademark), for example.

As shown in FIG. 1, the numerical control device 5 realizes various functions such as a function of controlling operation of the machine tool 2, and a function of generating movement paths of control axes of the robot 3, by way of the above-mentioned hardware configuration.

The numerical control device 5 includes a storage unit 51, a program input unit 52, an analysis unit 53, a control unit 54, a data transmitter receiver unit 55, an input unit 56, a program editing unit 57, and a display unit 58.

The storage unit 51, for example, stores a plurality of machining programs 511 created based on operations by the operator. More specifically, the storage unit 51 stores machining programs 511 configured by a plurality of command blocks for the machine tool 2 for controlling operation of the machine tool 2, a plurality of command blocks for the robot 3 for controlling the operation of the robot 3, etc. The machining programs 511 stored in the storage unit 51 are written in a known program language for controlling operation of the machine tool 2, such as G code and M code.

In addition, the storage unit 51 stores machine coordinate values indicating the positions of various axes (i.e. position of the tool post, table, etc. of the machine tool 2) of the machine tool 2 which operates under the above-mentioned numerical control program. It should be noted that these machine coordinate values are defined under the machine tool coordinate system with a reference point decided at any position on the machine tool 2 or in the vicinity of the machine tool 2 as the origin. The latest values for the machine coordinate values which sequentially change under the numerical control program are sequentially updated according by processing which is not shown, so as to be stored in the storage unit 51.

In addition, robot coordinate values indicating the position and posture of control points of the robot 3 operating under the control of the robot control device 6, i.e. position of each control axis of the robot 3, are stored in the storage unit 51. It should be noted that these robot coordinate values are defined under a robot coordinate system which differs from the machine tool coordinate system, as mentioned above. The latest values for the robot coordinate values which sequentially change under the numerical control program are sequentially updated according to the robot coordinate values acquired from the robot control device 6 by processing which is not shown, so as to be stored in the storage unit 51.

In addition, the storage unit 51 stores teaching positions such as the start point and end point of the robot 3 inputted by the operator. Specifically, the storage unit 51 stores teaching positions of the robot 3 inputted from the teach pendant or the like, teaching positions, etc. inputted from a keyboard or the like, etc. In the teaching position of the robot 3, the robot coordinate values indicating the position of each control axis of the robot 3 are included, and these robot coordinate values are defined under the robot coordinate system, which differs from the machine tool coordinate system.

The storage unit 51 further stores a custom macro variable (hereinafter also referred to as variables) 512, and variable list information 513.

The custom macro variable 512 can be used in the calculation of machining conditions, etc. of the machining program 511. The custom macro variable 512 can change the processing of the machining program, and change operation of the machine tool 2, in accordance with the values of the variable when used in a conditional expression. In the numerical control system 1 in which the machine tool 2 and robot 3 are interlocked with each other, the machine tool 2 and the robot 3 interlock with each other by the robot 3 reading and writing the custom macro variable 512.

The variable list information 513 stores to associate the variable 512, and program name of the machining program 511 using the variable 512.

The program input unit 52 reads the numerical control program for the robot configured by a plurality of robot command blocks from the storage unit 51, and inputs this Sequentially to the analysis unit 53.

The analysis unit 53 analyzes the command classification based on the numerical control program inputted from the program input unit 52 for every command block, and outputs the analysis result thereof to the control unit 54. More specifically, the analysis unit 53, in the case of the command classification of the command block being a machine tool numerical control command for the machine tool 2, sends this machine tool numerical control command to the control unit 54. The analysis unit 53, in the case of the command classification of the command block for a robot numerical control command for the robot 3, outputs this robot numerical control command to the control unit 54.

The control unit 54 generates machine tool control signals for controlling operation of the machine tool 2 according to the analysis result sent from the analysis unit 53, and inputs these to actuators driving various axes of the machine tool 2. The machine tool 2 operates according to the machine tool control signals inputted from the control unit 54, and machines a workpiece (not shown).

In addition, the control unit 54 generates robot command signals for every robot command block, based on the analysis results for every robot command block inputted from the analysis unit 53, and writes the generated robot command signals into the data transmitter receiver unit 55. Specifically, the control unit 54 generates robot command signals for every robot command block, based on the robot numerical control commands serving as analysis results inputted from the analysis unit 53, and writes the generated robot command signals into the data transmitter receiver unit 55.

The data transmitter receiver unit 55 sends and receives data such as commands, custom macro variables 512, robot coordinate values, etc. to and from the data transmitter receiver unit 65 of the robot control device 6. Specifically, the data transmitter receiver unit 55 sends the robot command signals generated by the control unit 54 to the data transmitter receiver unit 65 of the robot control device 6.

The input unit 56 is an input device such as a keyboard or mouse, a touch sensor configured integrally with the display unit 58, or the like, for example. The input unit 56 accepts inputs by the operator manipulating the numerical control device 5, and outputs these to the program editing unit 57.

The program editing unit 57 edits or creates a machining program 511 according to the inputs from the input unit 56, and saves this in the storage unit 51.

The display unit 58 is a liquid crystal display or the like, and displays various information in accordance with the control by the control unit 54. For example, the display unit 58 displays the variable list information 513.

Next, the configuration of the robot control device 6 will be described in detail. As shown in FIG. 1, in the robot control device 6, various functions are realized by the above-mentioned hardware configuration, such as of a storage unit 61, a program input unit 62, an analysis unit 63, a control unit 64, a data transmitter receiver unit 65, an input unit 66, a program editing unit 67 and a display unit 68. The robot control device 6 controls operation of the robot 3, based on commands sent from the robot program 611 or numerical control device 5, by using this program input unit 62, analysis unit 63, control unit 64 and data transmitter receiver unit 65.

The data transmitter receiver unit 65 receives the robot command signals sent from the data transmitter receiver unit 55 of the numerical control device 5. In addition, the data transmitter receiver unit 65 sequentially outputs the received robot command signals to the analysis unit 63. In addition, the data transmitter receiver unit 65 sends and receives the custom macro variables 512 of the numerical control device 5, based on the robot program 611.

The storage unit 61 stores the robot program 611 and variable list information 612. The variable list information 612 is stored to associate the variable 512 with the program name of machining program 511 and/or the robot program 611 using the variable 512.

The program input unit 62 reads the robot program 611 from the storage unit 61, and inputs this sequentially to the analysis unit 63.

The analysis unit 63 analyzes the command classification based on the robot program 611 inputted from the program input unit 62 for every command block, and outputs the analysis result thereof to the control unit 64. In addition, the analysis unit 63 analyzes the robot command signals inputted from the data transmitter receiver unit 65. The analysis unit 63 outputs the analysis result thereof to the control unit 64.

The control unit 64 executes the functions of the robot instruction generation unit, program management unit, path control unit, kinematics control unit, servo control unit, etc. such as those shown below.

The robot instruction generation unit generates a robot instruction according to the robot command signals, based on the analysis result of the robot command signals inputted from the analysis unit 63. The robot instruction generation unit outputs the generated robot instruction to the program management unit.

The program management unit, when the robot instruction is inputted from the robot instruction generation unit, generates an operation plan of the robot 3 according to the above-mentioned robot command signals, by sequentially executing the robot instructions, and outputs this to the path control unit.

In addition, the program management unit, in the case of the robot instructions inputted from the robot instruction generation unit being a block robot instruction, adds the inputted block robot instruction to the robot program stored in the storage unit 61. A robot program according to the robot command signals sent from the numerical control device 5 is thereby generated and stored in the storage unit 61. The stored robot program is started and reproduced by the program management unit receiving the robot program start command as a robot instruction.

The path control unit, when the operation plan is inputted from the program management unit, calculates time-series data of control points of the robot 3, and outputs this to the kinematics control unit.

The kinematics control unit calculates the target angle of each joint of the robot 3 from the inputted time-series data, and inputs these to the servo control unit.

The servo control unit generates robot control signals for the robot 3 by feedback controlling each servo motor of the robot 3 so that the target angles inputted from the kinematics control unit are realized, and inputs these to the servo motors of the robot 3.

The input unit 66, for example, is an input device such as a keyboard and mouse, a touch sensor configured integrally with the display unit 68, or the like. The input unit 66 accepts inputs by the operator manipulating the robot control device 6, and outputs these to the program editing unit 67.

The program editing unit 67 edits or creates a robot program 611 according to inputs from the input unit 66, and saves this in the storage unit 61.

The display unit 68 is a liquid crystal display or the like, and displays various information in accordance with control by the control unit 64. For example, the display unit 68 displays variable list information 612.

Next, the processing in the numerical control system 1 according to the present embodiment for preventing malfunctions which can occur in the case of using the custom macro variable 512 in the machining program 511 will be described.

The variable list information generation unit 41 of the industrial device 4 notifies the data transmitter receiver unit 43 of the industrial device 4 about the acquisition request of all machining program 511 stored in the storage unit 51 of the numerical control device 5. Herein, all of the machining programs 511 include the variable 512.

The data transmitter receiver unit 43 of the industrial device 4 acquires all of the machining programs 511 read out from the storage unit 51 of the numerical control device 5, via the data transmitter receiver unit of the numerical control device 5, and inputs these to the variable list information generation unit 41.

The variable list information generation unit 41 creates variable list information 513, and retrieves variables 512 included in the inputted machining program 511. The retrieved variable 512 is associated with machining programs 511 including this variable 512, and added to the variable list information 513. The variable list information generation unit 41, after retrieving all of the inputted machining programs 511, inputs the variable list information 513 to the variable list information output unit 42.

The variable list information output unit 42 outputs to the display unit 44 of the industrial device 4, and the display unit 44 displays the variable list information 513. The variable list information output unit 42 outputs the variable list information 513 to the data transmitter receiver unit 43 of the industrial device 4, and the data transmitter receiver unit of the industrial device 4 sends the variable list information 513 to the data transmitter receiver unit 55 of the numerical control device 5.

The numerical control device 5 saves the variable list information 513 received by the data transmitter receiver unit 55 in the storage unit 51. The numerical control device 5 can thereby use the variable list information 513 to avoid editing, creating and execution of a machining program 511 in which the variable 512 is duplicate.

Next, in the case of creating or editing a machining program 511, the input unit 56 of the numerical control device 5 notifies the program editing unit 57 about a request for creating or editing of the machining program 511.

In the case of creating a machining program 511, the program editing unit 57 generates the machining program 511, and stores this in the storage unit 51. In the case of editing a machining program 511, the program editing unit 57 reads the machining program 511 from the storage unit 51.

Upon editing a machining program 511, the variable 512 is inputted to the program editing unit 57 from the input unit 56. Then, the program editing unit 57 reads the variable list information 513 from the storage unit 51, and determines whether the inputted variable 512 is present in the variable list information 513.

The program editing unit 57, in the case of the variable 512 being present in the variable list information 513, determines the corresponding relationship between the machining program 511 being edited and the variable 512, based on the variable list information 513. In the variable list information 513, in the case of the machining program 511 being edited and the variable 512 not being associated, the program editing unit 57 causes a warning message to be displayed on the display unit 58, and deletes the inputted variable 512.

Upon saving the machining program 511, the program editing unit 57 reads the variable list information 513 from the storage unit 51. The program editing unit 57, in the case of using the variable 512 in the machining program 511, determines whether the used variable 512 is present in the variable list information 513.

In the case of the variable 512 being present in the variable list information 513, the program editing unit 57 determines the corresponding relationship between the saved machining program 511 and the variable 512, based on the variable list information 513.

The program editing unit 57, in the case of the machining program 511 and the variable 512 not being associated in the variable list information 513, causes a warning message to be displayed on the display unit 58, and inhibits saving of the machining program 511. The program editing unit 57, in the case of a variable not being present in the variable list information, or a case of the variable 512 having a corresponding relationship between the machining program 511 and the variable 512 being associated by the variable list information 513, saves the machining program 511.

Upon existing the machining program 511, the program input unit 52 reads the machining program 511 from the storage unit 51, and inputs this to the analysis unit 53. The analysis unit 53 analyzes the command classification based on the machining program 511 for every command block. The analysis unit 53, upon analyzing the variable 512, reads the variable list information 513 from the storage unit 51, and determines whether the variable 512 is present in the variable list information 513.

The analysis unit 53, in the case of the variable 512 being present in the variable list information 513, determines the corresponding relationship between the machining program 511 being executed and the variable 512, based on the variable list information 513. In the variable list information 513, in the case of the variable 512 not being associated with the machining program 511 being executed, the analysis unit 53 stops execution of the machining program.

In the case of the variable 512 not being present in the variable list information, or in the case of the machining program 511 and the variable 512 not being associated in the variable list information 513, the analysis unit 53 reads and writes the value of the variable 512 in the storage unit 51 in accordance with the analysis result. For example, upon the analysis unit 53 analyzing the movement command, the control unit 54 accepts the movement command, and drives the control axis of the machine tool 2 based on the movement command.

Next, a case of creating variable list information 612 from a machining program 511 and a robot program 611 will be described. The variable list information generation unit 41 notifies the data transmitter receiver unit 43 of the industrial device 4, about the acquisition request for all machining programs 511 including the variable 512 in the storage unit 51 of the numerical control device 5, and an acquisition request for all robot programs 611 including the variable 512 in the storage unit 61 of the robot control device 6.

The data transmitter receiver unit 43 of the industrial device 4 acquires all machining programs 511 including the variable 512 read from the storage unit 51, via the data transmitter receiver unit 55 of the numerical control device 5. In addition, the data transmitter receiver unit 43 acquires all robot programs 611 including the variable 512 read from the storage unit 61 of the robot control device 6, via the data transmitter receiver unit 65 of the robot control device 6. The data transmitter receiver unit 43 inputs all of the acquired machining programs 511 and all of the acquired robot programs 611 to the variable list information generation unit 41.

The variable list information generation unit 41 creates the variable list information 612, and retrieves for variables 512 included in the inputted machining programs 511 and robot programs 611. The variable list information generation unit 41 adds the retrieved variable 512 to the variable list information 612 to be associated with the machining program 511 or robot program 611 including this variable 512. The variable list information generation unit 41 retrieves all of the inputted machining programs 511 and robot programs 611, and then inputs the variable list information 612 to the variable list information output unit 42.

The variable list information output unit 42 causes the variable list information 612 to be displayed on the display unit 44. The variable list information output unit 42 outputs the variable list information 612 to the data transmitter receiver unit 55, and the data transmitter receiver unit 43 sends the variable list information 612 to the data transmitter receiver unit 65 of the robot control device 6.

The robot control device 6 saves the variable list information 612 received by the data transmitter receiver unit 65 in the storage unit 61 of the robot control device 6.

Next, a case of creating or editing a robot program 611 will be described. The input unit 66 of the robot control device 6 notifies the program editing unit 67 about a request for creating or editing a robot program 611.

In the case of creating the robot program 611, the program editing unit 67 generates the robot program 611, and stores this in the storage unit 61. In the case of editing the robot program 611, the program editing unit 67 reads the robot program 611 from the storage unit 61.

Upon editing the robot program, the input unit 66 inputs the variable 512 into the program editing unit 67. The program editing unit 67 reads the variable list information 612 from the storage unit 61, and determines whether the inputted variable 512 is a variable present in the variable list information 612. In the case of the variable 512 being present in the variable list information 612, the program editing unit 67 determines the corresponding relationship between the robot program 611 being edited and the variable 512, based on the variable list information 612.

The program editing unit 67, in the case of the machining program 511 or robot program 611 and the variable 512 not being associated in the variable list information 612, causes a warning message to be displayed on the display unit 68 of the robot control device 6, and deletes the inputted variable 512.

Upon saving the robot program 611, the program editing unit 67 reads the variable list information 612 from the storage unit 61. In the case of using a variable 512 in the robot program 611, it determines whether the used variable 512 is present in the variable list information.

In the case of the variable 512 being present in the variable list information 612, the program editing unit 67 determines the corresponding relationship between the robot program 611 and the variable 512, based on the variable list information 612. In the case of the robot program 611 and the variable 512 not being associated in the variable list information 612, the program editing unit 67 causes a warning message to be displayed on the display unit 68, and inhibits saving of the robot program 611.

In the case of the variable 512 not being present in the variable list information 612, or the case of the corresponding relationship between the robot program 611 and the variable 512 being associated by the variable list information 612, the program editing unit 67 saves the robot program 611 in the storage unit 61.

In the case of executing the robot program 611, the program input unit 62 reads the robot program 611 from the storage unit 61, and inputs this to the analysis unit 63.

The analysis unit 63 analyzes the command classification based on the robot program 611, for every command block. Upon analyzing the variable 512, the analysis unit 63 reads the variable list information 612 from the storage unit 61, and determines whether the variable 512 is present in the variable list information 612.

In the case of the variable 512 being present in the variable list information 612, the analysis unit 63 determines the corresponding relationship between the robot program 611 being executed and the variable 512, based on the variable list information 612.

In the variable list information 612, in the case of the variable 512 not being associated with the robot program 611 being executed, the analysis unit 63 stops execution of the robot program 611. In the case of the variable 512 not being present in the variable list information, or the case of the robot program 611 and the variable 512 being associated in the variable list information 612, the analysis unit 63 reads the variable 512 in the storage unit 51 of the numerical control device 5, via the data transmitter receiver unit 55 and the data transmitter receiver unit 65, in accordance with the analysis result. For example, upon the analysis unit 63 analyzing movement commands, the control unit 64 drives each joint of the robot 3 based on the movement commands.

### First Embodiment

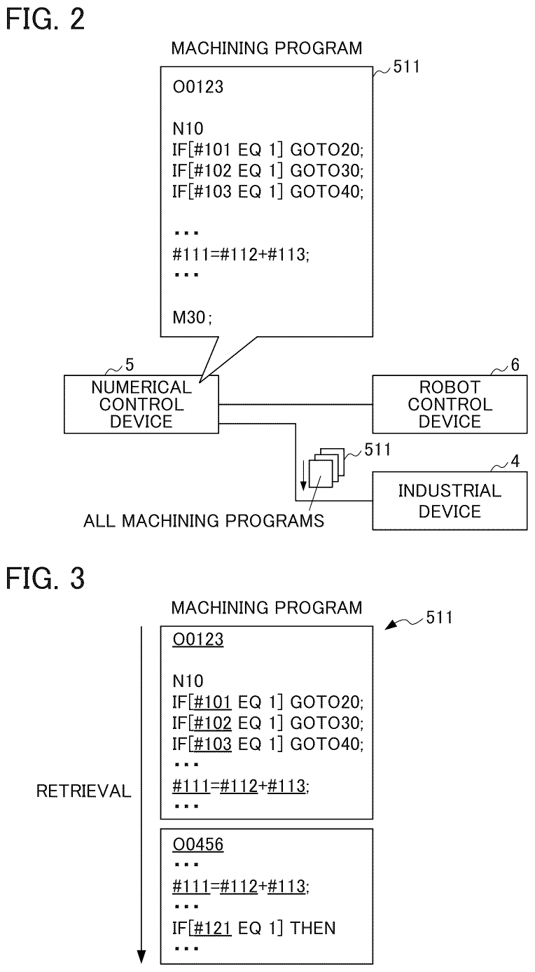

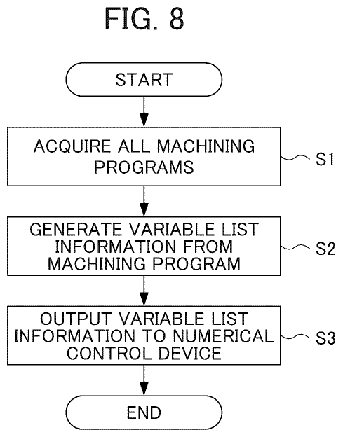

Processing of a numerical control system 1 according to a first embodiment will be described while referencing FIGS. 2 to 10. FIGS. 2 to 7 are views showing examples of processing of the numerical control system 1 according to the first embodiment, and FIGS. 8 to 10 are flowcharts showing the flow of processing of the numerical control system 1 according to the first embodiment.

The numerical control system 1 according to the first embodiment uses in execution of an existing machining program 511a, a variable 512 which is in use of the machining program 511.

FIG. 8 is a flowchart showing processing of an industrial device 4 according to the first embodiment. In Step S1, the variable list information generation unit 41 notifies the data transmitter receiver unit 43 of the industrial device 4 about an acquisition request for all machining programs 511 stored in the storage unit 51 of the numerical control device 5.

Herein, all of the machining programs 511 include the variable 512. The data transmitter receiver unit 43 acquires all of the machining programs 511 read from the storage unit 51 of the numerical control device 5 via the data transmitter receiver unit 55 of the numerical control device 5, and inputs these to the variable list information generation unit 41 (refer to FIG. 2).

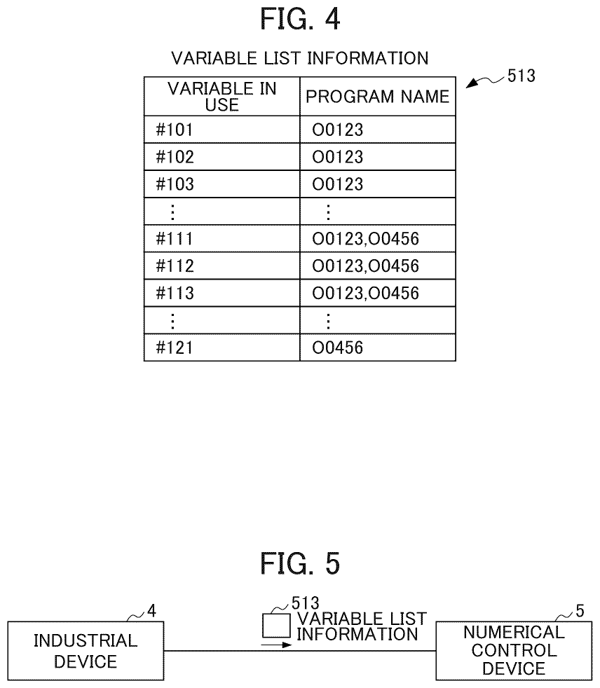

In Step S2, the variable list information generation unit 41 creates a variable list information 513, and retrieves for variables 512 included in the inputted machining program 511 (refer to FIG. 3). The retrieved variable 512 is associated with the machining program 511 including this variable 512, and is added to the variable list information 513 (refer to FIG. 4). Herein, as shown in FIG. 4, the variable list information 513 stores the variable 512 in use to be associated with the program name of the machining program 511 using the variable 512. The variable list information generation unit 41, after retrieving all inputted machining programs 511, inputs the variable list information 513 to the variable list information output unit 42.

In Step S3, the variable list information output unit 42 outputs the variable list information 513 to the data transmitter receiver unit 43 of the industrial device 4, and the data transmitter receiver unit of the industrial device 4 sends the variable list information 513 to the data transmitter receiver unit 55 of the numerical control device 5 (refer to FIG. 5).

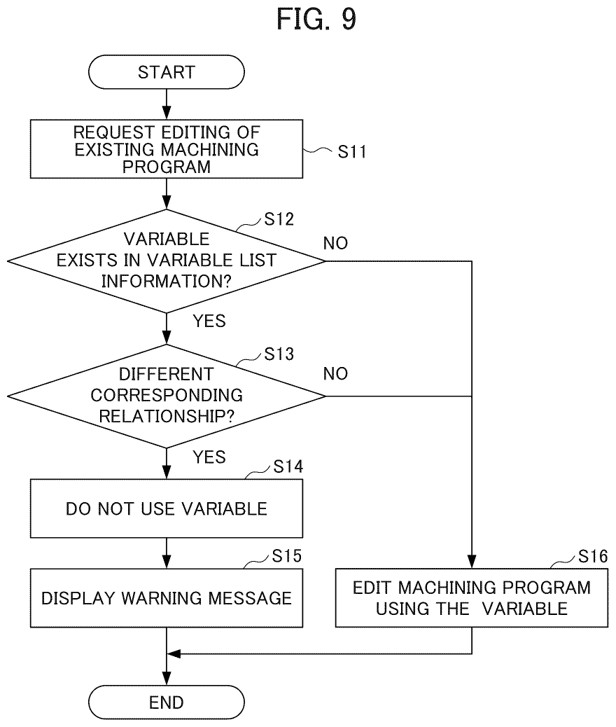

FIG. 9 is a flowchart showing processing in the case of performing editing of the machining program 511 in the numerical control device 5 according to the first embodiment. In Step S11, the input unit 56 of the numerical control device 5 notifies the program editing unit 57 about a request for editing of the machining program 511a. The program editing unit 57 reads the machining program 511a from the storage unit 51, and the input unit 56 inputs the variable 512 to the program editing unit 57. In addition, the program editing unit 57 reads the variable list information 513 from the storage unit 51.

In Step S12, the program editing unit 57 determines whether the inputted variable 512 is present in the variable list information 513. In the case of the inputted variable 512 being present in the variable list information 513 (YES), the processing advances to Step S13. On the other hand, in the case of the variable 512 not being present in the variable list information 513 (NO), the processing advances to Step S16.

In Step S13, the program editing unit 57, in the case of the variable 512 being present in the variable list information 513, determines the corresponding relationship between the machining program 511a being edited and the variable 512, based on the variable list information 513. In the case of the corresponding relationship between the machining program 511a and variable 512 being different, i.e. case of the machining program 511a and the variable 512 not being associated (YES), the processing advances to Step S14. On the other hand, in the case of the machining program 511a and the variable 512 being associated (NO), the processing advances to Step S16.

In Step S14, the program editing unit 57 deletes without using the inputted variable 512 in an existing machining program 511a.

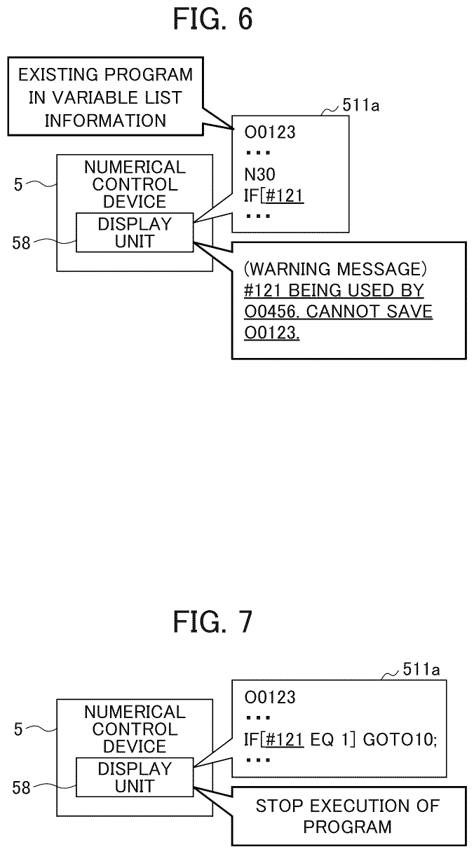

In Step S15, the program editing unit 57 causes a warning message to be displayed on the display unit 58 (refer to FIG. 6). In the example of FIG. 6, the display unit 58 displays a warning message indicating “variable #121 is being used by machining program name 00456, and cannot save machining program name 00123”. Herein, machining program name 00123 indicates the machining program 511a.

In Step S16, the program editing unit 57 performs editing of an existing machining program 511a using the variable 512.

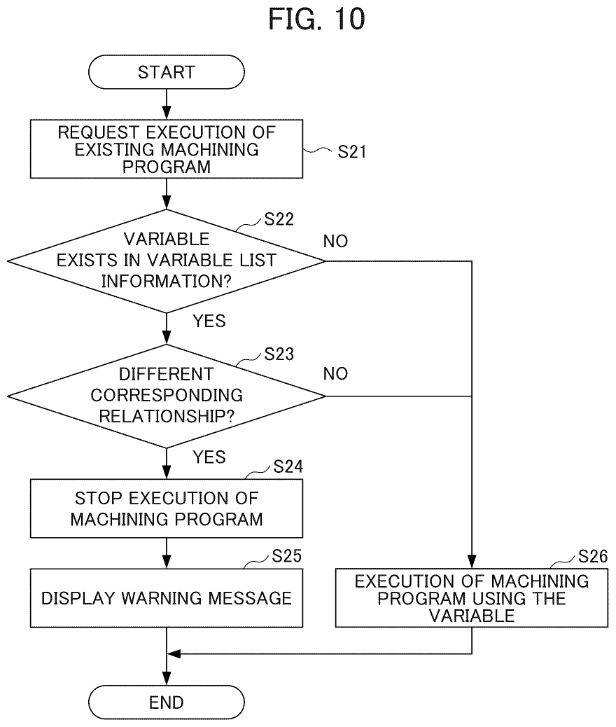

FIG. 10 is a flowchart showing the processing of the numerical control device 5 according to the first embodiment. In Step S21, the input unit 56 of the numerical control device 5 notifies the program editing unit 57 about a request for execution of the machining program 511a. The program editing unit 57 reads the machining program 511a from the storage unit 51, and the input unit 56 inputs the variable 512 to the program editing unit 57. In addition, the program editing unit 57 reads the variable list information 513 from the storage unit 51.

In Step S22, the program editing unit 57 determines whether the inputted variable 512 is present in the variable list information 513. In the case of the inputted variable 512 being present in the variable list information 513 (YES), the processing advances to Step S23. On the other hand, in the case of the variable 512 not being present in the variable list information 513 (NO), the processing advances to Step S26.

In Step S23, the program editing unit 57, in the case of the variable 512 being present in the variable list information 513, determines the corresponding relationship between the machining program 511a and the variable 512 based on the variable list information 513. In the case of the corresponding relationship between the machining program 511a and the variable 512 differing, i.e. case of the machining program 511a and the variable 512 not being associated (YES), the processing advances to Step S24. On the other hand, in the case of the machining program 511a and the variable 512 being associated (NO), the processing advances to Step S26.

In Step S24, the program editing unit 57 stops or inhibits execution of the machining program 511a without using the inputted variable 512, in an existing machining program 511a.

In Step S25, the program editing unit 57 causes a warning message indicating that it is not possible to execute the existing machining program 511a to be displayed on the display unit 58 (refer to FIG. 7).

In Step S26, the program editing unit 57 executes the existing machining program 511a, using the variable 512.

According to such a configuration, the numerical control system 1 according to the first embodiment notifies the numerical control device 5 about the variable list information 513 of the variable 512 associated with the machining programs 511, from among all of the machining programs 511. The numerical control system 1 can thereby avoid editing of a machining program in which variable associated with a machining program is duplicate.

In addition, the numerical control system 1, in the case of the machining program for which the variable associated with the machining program is duplicate being executed, stops or inhibits execution of the machining program based on the variable list information. The numerical control system 1 can thereby avoid malfunctions such as a machining defect which can occur by duplication of the variable associated with the machining programs, breakage of the machine tool 2, and collision between the machine tool 2 and the robot 3.

Furthermore, the numerical control system 1 creates the variable list information 513 of the variable 512 associated with the machining program 511 from all machining programs 511 of the numerical control device 5, and outputs and displays the variable list information 513. The numerical control system 1 can thereby eliminate the labor for confirming the machining program, when determining the variable to be used in a new application.

In addition, in the numerical control system 1, the matter of not using a variable includes at least one among inhibiting saving of a variable, inhibiting referencing of a variable, and inhibiting execution of the machining program including the variable. By way of such a configuration, the numerical control system 1 can appropriately avoid malfunctions such as a machining defect which can occur by duplication of the variable associated with machining programs, breakage of the machine tool 2, and collision between the machine tool 2 and the robot 3.

In addition, the numerical control device 5, in the case of not using the variable, further includes a display unit 58 which displays a warning message indicating the matter of not using the variable. By way of such a configuration, the numerical control system 1 can appropriately inform the user about the matter of not using the variable.

### Second Embodiment

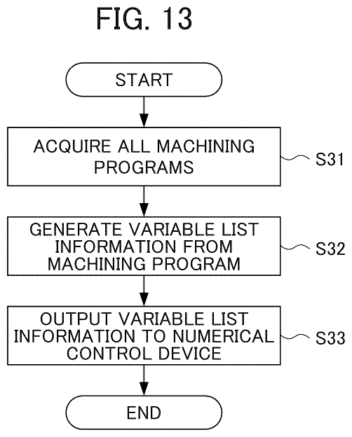

Processing of the numerical control system 1 according to a second embodiment will be described while referencing FIGS. 2 to 5 and FIGS. 11 to 15. FIGS. 2 to 5, and FIGS. 11 and 12 are views showing examples of processing of the numerical control system 1 according to the second embodiment, and FIGS. 13 to 15 are flowcharts showing the flow of processing of the numerical control system 1 according to the second embodiment.

The numerical control system 1 according to the second embodiment uses in execution of a new machining program 511b, a variable 512 in use of the machining program 511.

FIG. 13 is the flowchart showing the processing of the industrial device 4 according to the second embodiment. In Step S31, the variable list information generation unit 41 notifies the data transmitter receiver unit 43 of the industrial device 4 about the acquisition request for all machining programs 511 stored in the storage unit 51 of the numerical control device 5. Herein, all of the machining programs 511 include the variable 512. The data transmitter receiver unit 43, via the data transmitter receiver unit 55 of the numerical control device 5, acquires all of the machining programs 511 read from the storage unit 51 of the numerical control device 5, and inputs these to the variable list information generation unit 41 (refer to FIG. 2).

In Step S32, the variable list information generation unit 41 creates the variable list information 513, and retrieves the variable 512 included in the inputted machining program 511 (refer to FIG. 3). The retrieved variable 512 is associated with the machining programs 511 including this variable 512, and is added to the variable list information 513 (refer to FIG. 4). Herein, as shown in FIG. 4, in the variable list information 513, the variable 512 in use, and the program name of the machining program 511 using the variable 512 are stored to be associated. The variable list information generation unit 41, after retrieving all of the inputted machining programs 511, inputs the variable list information 513 to the variable list information output unit 42.

In Step S33, the variable list information output unit 42 outputs the variable list information 513 to the data transmitter receiver unit 43 of the industrial device 4, and the data transmitter receiver unit of the industrial device 4 sends the variable list information 513 to the data transmitter receiver unit 55 of the numerical control device 5 (refer to FIG. 5).

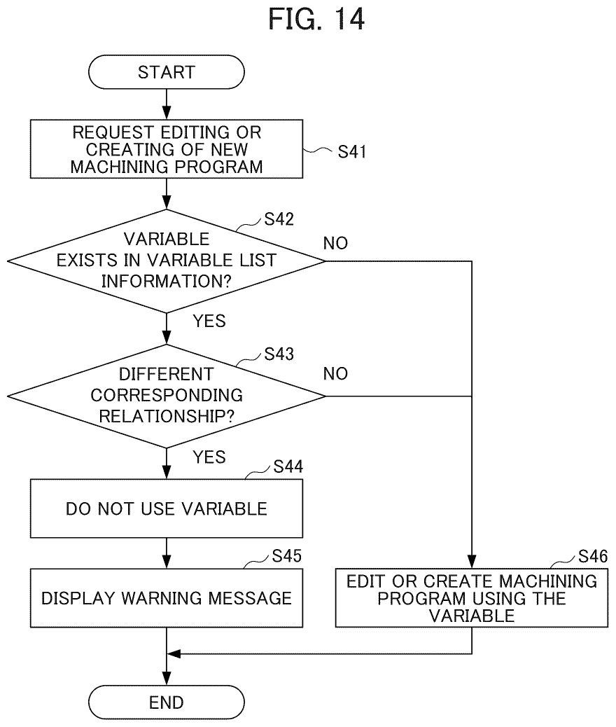

FIG. 14 is a flowchart showing the processing in the numerical control device 5 according to the second embodiment in the case of performing editing or creating of a machining program 511b. In Step S41, the input unit 56 of the numerical control device 5 notifies the program editor 57 about a request for editing or creating a machining program 511b. The program editing unit 57 reads a machining program 511b from the storage unit 51, and the input unit 56 inputs the variable 512 to the program editing unit 57. In addition, the program editing unit 57 reads the variable list information 513 from the storage unit 51.

In Step S42, the program editing unit 57 determines whether the inputted variable 512 is present in the variable list information 513. In the case of the inputted variable 512 being present in the variable list information 513 (YES), the processing advances to Step S43. On the other hand, in the case of the inputted variable 512 not being present in the variable list information 513 (NO), the processing advances to Step S46.

In Step S43, the program editing unit 57, in the case of the variable 512 being present in the variable list information 513, determines the corresponding relationship between the machining program 511b and the variable 512 based on the variable list information 513. In the case of the corresponding relationship between the machining program 511b and variable 512 differing, i.e. case of the machining program 511b and the variable 512 not being associated (YES), the processing advances to Step S44. On the other hand, in the case of the machining program 511 and the variable 512 being associated (NO), the processing advances to Step S46.

In Step S44, the program editing unit 57 deletes without using the inputted variable 512 in the new machining program 511b. In addition, the program editing unit 57 may inhibit saving of the new machining program 511b, without using the inputted variable 512.

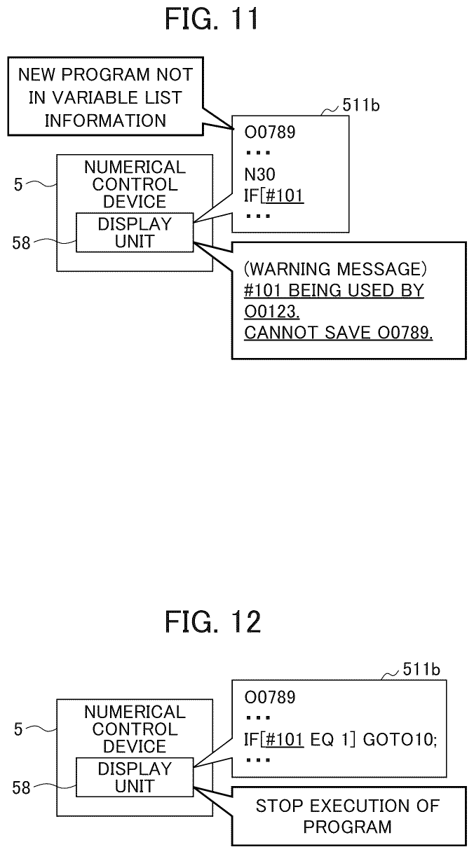

In Step S45, the program editing unit 57 causes a warning message to be displayed on the display 58 (refer to FIG. 11). In the example of FIG. 11, the display 58 displays a warning message indicating “variable #101 is being used by machining program name 00123, and cannot save machining program name 00789”. Herein, the machining program name 00789 indicates the machining program 511b.

In Step S46, the program editor 57 uses the variable 512 and performs editing or creating of a new machining program 511b.

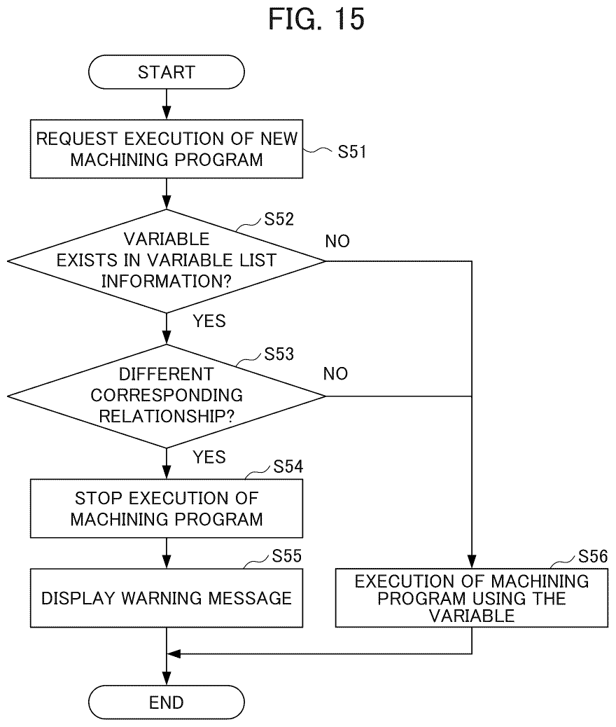

FIG. 15 is a flowchart showing the processing of the numerical control device 5 according to the second embodiment. In Step S51, the input unit 56 of the numerical control device 5 notifies the program editor 57 about a request for execution of the machining program 511b. The program editor 57 reads the machining program 511b from the storage unit 51, and the input unit 56 inputs the variable 512 to the program editing unit 57. In addition, the program editing unit 57 reads the variable list information 513 from the storage unit 51.

In Step S52, the program editing unit 57 determines whether the inputted variable 512 is present in the variable list information 513. In the case of the inputted variable 512 being present in the variable list information 513 (YES), the processing advances to Step S53. On the other hand, in the case of the variable 512 not being present in the variable list information 513 (NO), the processing advances to Step S56.

In Step S53, the program editing unit 57, in the case of the variable 512 being present in the variable list information 513, determines the corresponding relationship between the machining program 511b and the variable 512, based on the variable list information 513. In the case of the corresponding relationship between the machining program 511b and variable 512 differing, i.e. case of the machining program 511b and the variable 512 not being associated (YES), the processing advances to Step S54. On the other hand, in the case of the machining program 511b and the variable 512 being associated (NO), the processing advances to Step S56.

In Step S54, the program editing unit 57 stops or inhibits the execution of the machining program 511b, without using the inputted variable 512 in the machining program 511b.

In Step S55, the program editing unit 57 causes a warning message indicating that the machining program 511b cannot be executed to be displayed on the display unit 58 (refer to FIG. 12).

In Step S56, the program editing unit 57 uses the variable 512 to execute a new machining program 511b.

According to such a configuration, the numerical control system 1 according to the second embodiment notifies the numerical control device 5 about the variable list information 513 of the variable 512 associated with the machining program 511, from all of the machining programs 511. The numerical control system 1 can thereby avoid editing or creating a machining program in which the variable associated with the machining program is duplicate.

In addition, the numerical control system 1, in the case of a machining program for which a variable associated with the machining program is duplicate being executed, stops or inhibits execution of the machining program based on the variable list information. The numerical control system 1 can thereby avoid malfunctions such as a machining defect which can occur by duplication of a variable associated with the machining programs, breakage of the machine tool 2, and collision between the machine tool 2 and the robot 3.

### Third Embodiment

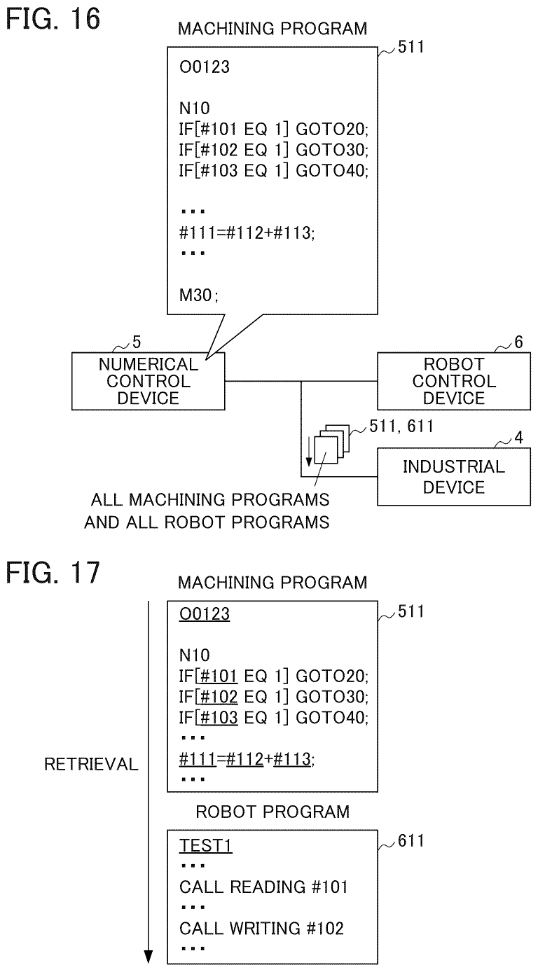

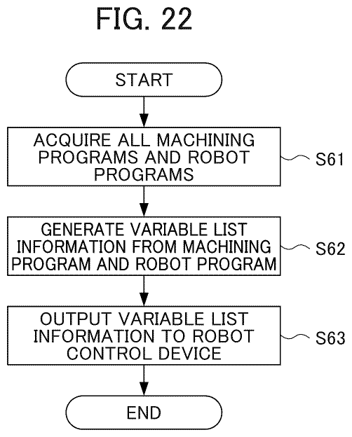

The processing of a numerical control system 1 according to a third embodiment will be described while referencing FIGS. 16 to 24. FIGS. 16 to 21 are views showing examples of processing of the numerical control system 1 according to the third embodiment, and FIGS. 22 to 24 are flowcharts showing the flow of processing of the numerical control system 1 according to the third embodiment. The numerical control system 1 according to the third embodiment uses in execution of a robot program 611a, a variable 512 in use of the machining program 511.

FIG. 22 is a flowchart showing the processing of an industrial device 4 according to the third embodiment. In Step S61, the variable list information generation unit 41 notifies the data transmitter receiver unit 43 of the industrial device 4, about an acquisition request for all machining programs 511 including the variable 512 in the storage unit 51 of the numerical control device 5, and an acquisition request for all robot programs 611 including the variable 512 in the storage unit 61 of the robot control device 6.

The data transmitter receiver unit 43, via the data transmitter receiver unit 55 of the numerical control device 5, acquires all machining programs 511 including the variable 512 read from the storage unit 51. In addition, the data transmitter receiver unit 43, via the data transmitter receiver unit 65 of the robot control device 6, acquires all robot programs 611 including the variable 512 read from the storage unit 61 of the robot control device 6. The data transmitter receiver unit 43 inputs all of the machining programs 511 and all of the robot programs 611 thus acquired into the variable list information generation unit 41 (refer to FIG. 16).

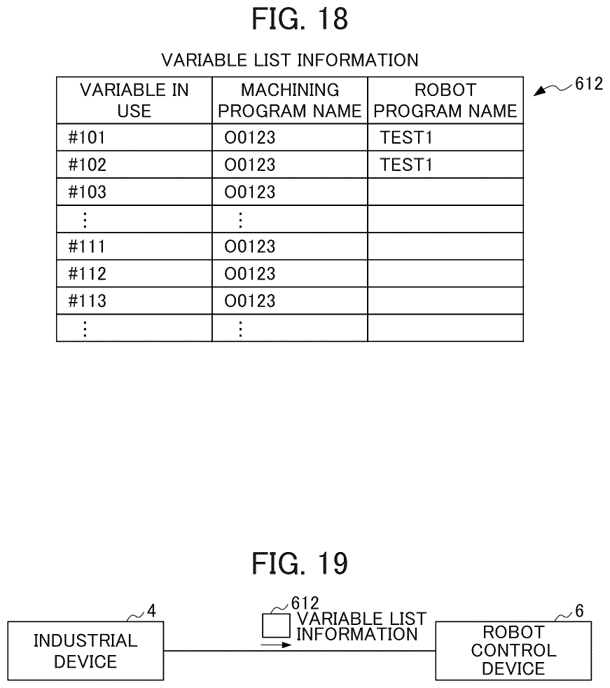

In Step S62, the variable list information generation unit 41 creates the variable list information 612, and retrieves the variables 512 included in the inputted machining programs 511 and robot programs 611 (refer to FIG. 17). The variable list information generation unit 41 adds the retrieved variable 512 to the variable list information 612 to be associated with the machining program 511 or robot program 611 including this variable 512 (refer to FIG. 18). Herein, as shown in FIG. 18, in the variable list information 612, the variable in use and the program name of the machining program 511 and/or robot program 611 are stored to be associated. The variable list information generation unit 41, after retrieving all of the inputted machining programs 511 and robot programs 611, inputs the variable list information 612 to the variable list information output unit 42.

In Step S63, the variable list information output unit 42 outputs the variable list information 612 to the data transmitter receiver unit 55, and the data transmitter receiver unit 43 outputs the variable list information 612 to the data transmitter receiver unit 65 of the robot control device 6.

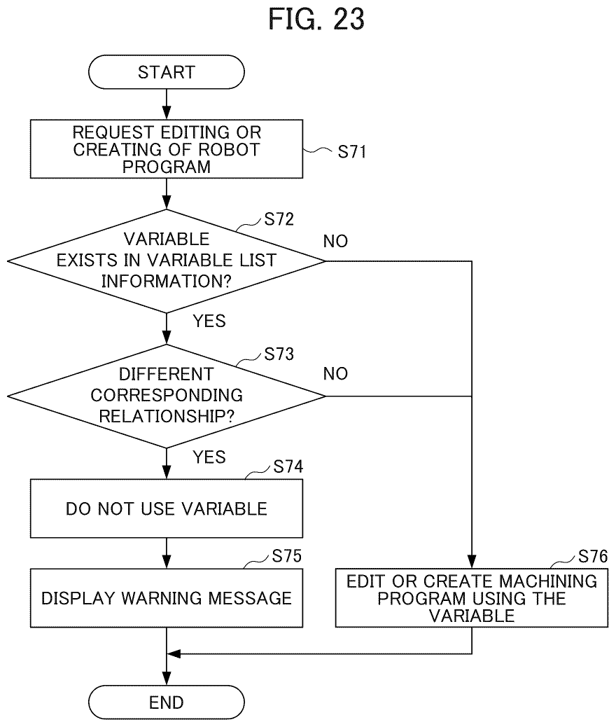

FIG. 23 is a flowchart showing the processing in the case of performing editing or creating of the robot program 611a in the robot control device 6 according to the third embodiment. In Step S71, the input unit 66 of the robot control device 6 notifies the program editing unit 67 about a request for creating or editing the robot program 611. In the case of creating the robot program 611, the program editor 67 generates the robot program 611, and stores this in the storage unit 61. In the case of editing the robot program 611, the program editing unit 67 reads the robot program 611 from the storage unit 61. Upon editing the robot program, the input unit 66 inputs the variable 512 to the program editing unit 67.

In Step S72, the program editing unit 67 reads the variable list information 612 from the storage unit 61, and determines whether the inputted variable 512 is present in the variable list information 612. In the case of the inputted variable 512 being present in the variable list information 612 (YES), the processing advances to Step S73. On the other hand, in the case of the variable 512 not being present in the variable list information 612 (NO), the processing advances to Step S76.

In Step S73, the program editing unit 67, in the case of the variable 512 being present in the variable list information 612, determines the corresponding relationship between the robot program 611a and the variable 512 based on the variable list information 612. In the case of the corresponding relationship between the robot program 611a and the variable 512 differing, i.e. the robot program 611a and the variable 512 not being associated (YES), the processing advances to Step S74. On the other hand, in the case of the robot program 611a and the variable 512 being associated (NO), the processing advances to Step S76.

In Step S74, the program editing unit 67 deletes without using the inputted variable 512 in the robot program 611a. In addition, the program editing unit 67 may inhibit saving of the robot program 611a, without using the inputted variable 512.

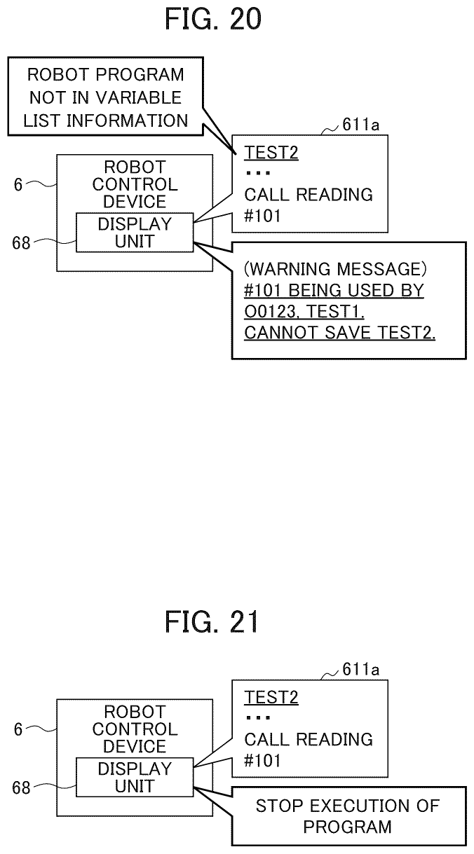

In Step S75, the program editing unit 57 causes a warning message to be displayed on the display unit 68 (refer to FIG. 20). In the example of FIG. 20, the display unit 68 displays a warning message indicating that “variable #101 is being used in machining program name 00123 and robot program name TEST1, and cannot save robot program name TEST2”. Herein, the robot program name TEST2 indicates the robot program 611a.

In Step S76, the program editing unit 67 uses the variable 512 to perform editing or creating the robot program 611a.

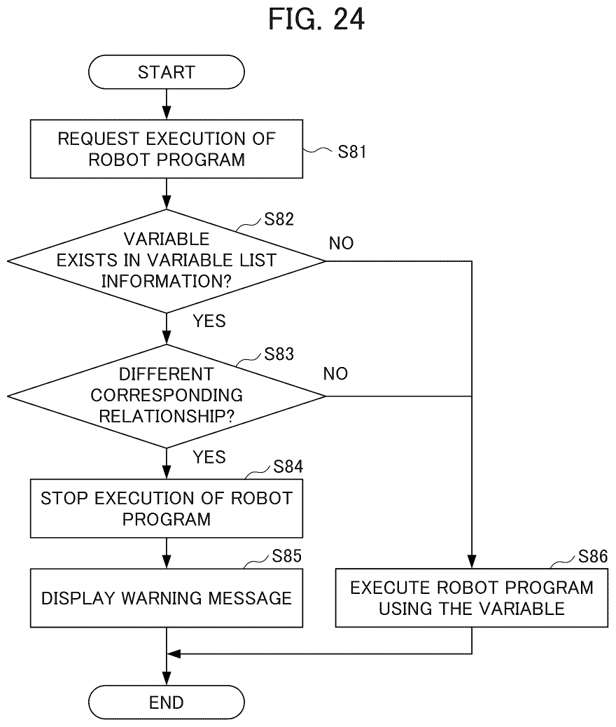

FIG. 24 is a flowchart showing the processing in the robot control device 6 according to the third embodiment in the case of executing the robot program 611a. In Step S81, in the case of executing the robot program 611, the program input unit 62 reads the robot program 611 from the storage unit 61, and inputs this to the analysis unit 63.

In Step S82, the analysis unit 63 analyzes the command classification based on the robot program 611a for every command block. Upon analyzing the variable 512, the analysis unit 63 reads the variable list information 612 from the storage unit 61, and determines whether the variable 512 is present in the variable list information 612. In the case of the variable 512 being present in the variable list information 612 (YES), the processing advances to Step S83. On the other hand, in the case of the variable 512 not being present in the variable list information 612 (NO), the processing advances to Step S86.

In Step S83, the analysis unit 63 determines the corresponding relationship between the robot program 611a being executed and the variable 512, based on the variable list information 612. In the case of the corresponding relationship between the robot program 611a and the variable 512 differing, i.e. case of the variable 512 not being associated with the robot program 611a being executed (YES), the processing advances to Step S84. On the other hand, in a case of the variable 512 not being present in the variable list information, or a case of the robot program 611 and the variable 512 being associated in the variable list information 612 (NO), the processing advances to Step S86.

In Step S84, the analysis unit 63 stops or inhibits execution of the robot program 611a without using the variable 512 in the robot program 611a.

In Step S85, the analysis unit 63 causes a warning message indicating that it is not possible to execute the robot program 611a to be displayed on the display unit 68 (refer to FIG. 21).

In Step S86, the analysis unit 63 executes the robot program 611a using the variable 512. Specifically, the controller 64 reads and writes the variable 512 in the storage unit 51 of the numerical control device 5, via the data transmitter receiver unit 55 and the data transmitter receiver unit 65, in accordance with the analysis results. For example, upon the analysis unit 63 analyzing a movement command, the control unit 64 drives each joint of the robot 3 based on the movement commands.

According to such a configuration, the numerical control system 1 according to the third embodiment notifies the robot control device 6 about the variable list information 612. Thereby, the numerical control system 1, for example, inhibits saving of a robot program made using the variable associated with the machining program based on the variable list information during robot program editing, and notifies of a warning message. The numerical control system 1 can thereby avoid creating a robot program made duplicately using a variable associated with the machining program.

In addition, the numerical control system 1, in the case of a robot program made duplicately using a variable associated with a machining program being executed, inhibits execution of the robot program prior to reading and writing the variable associated with the machining program based on the variable list information. The numerical control system 1 can thereby avoid malfunctions such as a machining defect which can occur by the robot 3 writing the value of a variable in the machining program, breakage of the machine tool 2, and collision between the machine tool 2 and the robot 3 which can occur by the robot 3 reading the value of a variable in the machining program.

In addition, the variable list information generation unit 41 acquires the variable 512 from within all robot programs 611 in the robot control device 6, and adds an association between the variable 512 and the robot program 611 to the variable list information 612. The program editing unit 67, in the case of a variable 512 included in the variable list information 612 being used by a robot program 611 not present in the variable list information 612, does not use the variable 512.

The numerical control system 1 can thereby avoid malfunctions such as a machining defect which can occur by the robot 3 writing the value of a variable 512 in the machining program 511, breakage of the machine tool 2, and collision between the machine tool 2 and the robot 3 which can occur by the robot 3 reading the value of a variable 512 in the machining program 511.

In addition, in the numerical control system 1, the matter of not using a variable includes at least one among inhibiting saving of the variable, inhibiting referencing of the variable, and inhibiting execution of a robot program including the variable. By way of such a configuration, the numerical control system 1 can appropriately avoid malfunctions such as a machining defect which can occur by duplication of a variable associated with the machining program or the robot program, breakage of the machine tool 2, and collision between the machine tool 2 and the robot 3.

In addition, the robot control device 6 further includes a display unit 68 which, in the case of not using a variable, displays a warning message indicating the matter of not using the variable. By way of such a configuration, the numerical control system 1 can appropriately inform the user about the matter of not using the variable.

### Fourth Embodiment

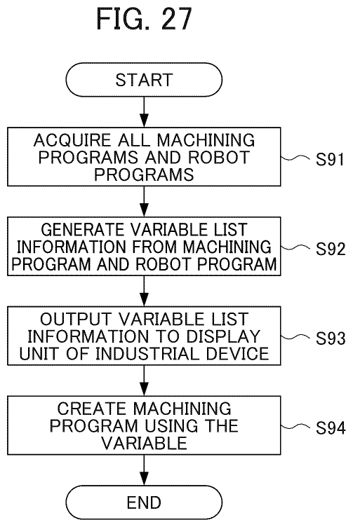

The processing of the numerical control system 1 according to a fourth embodiment will be described while referencing FIGS. 16 to 19 and FIGS. 25 to 27. FIGS. 16 to 19, and FIGS. 25 and 26 are views showing examples of processing of the numerical control system 1 according to the fourth embodiment, and FIG. 27 is a flowchart showing the flow of processing of the numerical control system 1 according to the fourth embodiment.

The numerical control system 1 according to the fourth embodiment displays the variable list information on the industrial device 4.

FIG. 27 is a flowchart showing the processing of the industrial device 4 according to the third embodiment. In Step S91, the variable list information generation unit 41 notifies the data transmitter receiver unit 43 of the industrial device 4 about an acquisition request for all machining programs 511 including the variable 512 in the storage unit 51 of the numerical control device 5, and an acquisition request for all robot programs 611 including the variable 512 in the storage unit 61 of the robot control device 6.

The data transmitter receiver unit 43 acquires all machining programs 511 including the variable 512 read from the storage unit 51, via the data transmitter receiver unit 55 of the numerical control device 5. In addition, the data transmitter receiver unit 43 acquires all robot programs 611 including the variable 512 read from the storage unit 61 of the robot control device 6 via the data transmitter receiver unit 65 of the robot control device 6. The data transmitter receiver unit 43 inputs all of the acquired machining programs 511 and all of the acquired robot programs 611 to the variable list information generation unit 41 (refer to FIG. 16).

In Step S92, the variable list information generation unit 41 creates the variable list information 612, and retrieves variables 512 included in the inputted machining program 511 and robot program 611 (refer to FIG. 17). The variable list information generation unit 41 adds the retrieved variable 512 to the variable list information 612 to be associated with the machining program 511 or robot program 611 including this variable 512 (refer to FIG. 18). Herein, as shown in FIG. 18, in the variable list information 612, the variable in use, and the program name of the machining program 511 and/or robot program 611 are stored to be associated. The variable list information generation unit 41, after retrieving all of the inputted machining programs 511 and robot programs 611, inputs the variable list information 612 to the variable list information output unit 42.

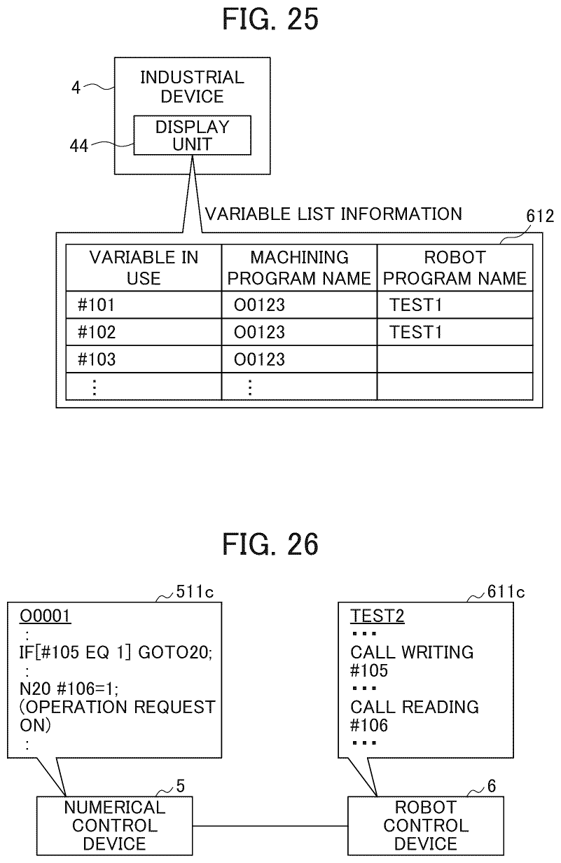

In Step S93, the variable list information output unit 42 causes the variable list information 612 to be displayed on the display unit 44 (refer to FIG. 25). In addition, the variable list information output unit 42 outputs the variable list information 612 to the data transmitter receiver unit 55, and the data transmitter receiver unit 43 sends the variable list information 612 to the data transmitter receiver unit 65 of the robot control device 6. In addition, the data transmitter receiver unit 43 sends the variable list information 612 to the data transmitter receiver unit 55 of the numerical control device 5.

In Step S94, the numerical control device 5 saves the variable list information 612 in the storage unit 51, and the robot control device 6 saves the variable list information 612 in the storage unit 61. Upon creating the machining program 511, the numerical control device 5 uses a variable not included in the machining program 511 or the robot program 611 in the variable list information 612 to create a new machining program 511c, and create a new robot program 611c (refer to FIG. 26).

By way of such a configuration, the numerical control system 1 according to the fourth embodiment can avoid creation of a machining program made by duplicately using a variable 512 associated with the machining program 511. In addition, the numerical control system 1 creates the variable list information 612 of the variable 512 associated with the machining program 511 from all of the machining programs 511 of the numerical control device, and outputs the variable list information 612. The numerical control system 1 can thereby eliminate the labor of confirming the machining program 511, when determining a variable to be used in a new application.

In addition, the variable list information generation unit 41 acquires the variable 512 from within all robot programs 611 in the robot control device 6, and adds an association between the variable 512 and the robot program 611 to the variable list information 612. The numerical control system 1 can thereby avoid malfunctions such as a machining defect which can occur by the robot 3 writing the value of the variable 512 in the machining program 511, breakage of the machine tool 2, and collision between the machine tool 2 and the robot 3 which can occur by the robot 3 reading the value of the variable 512 in the machining program 511.

In addition, the industrial device 4 further includes a display unit 44 which displays the association between the variable 512 and the machining program 511 or the robot program 611 based on the variable list information 612. By way of such a configuration, the numerical control system can appropriately inform the user about the matter of not using the variable 512.

Although embodiments of the present invention have been described above, the above-mentioned numerical control system 1 can be realized by way of hardware, software or a combination of these. In addition, the control method performed by the above-mentioned numerical control system 1 can also be realized by hardware, software or a combination of these. Herein, being realized by software indicates being realized by a computer reading and executing a program.

The program can be stored using various types of non-transitory computer readable medium, and supplied to the computer. Non-transitory computer readable medium includes various types of tangible storage media. Examples of non-transitory computer readable media include magnetic media (for example, hard disk drive), magneto-optical recording media (for example, magneto-optical disk), CD-ROM (Read Only Memory), CD-R, CD-R/W, and semiconductor memory (for example, mask ROM, PROM (Programmable ROM), EPROM (Erasable PROM), flash ROM, RAM (random access memory)).

Although the present disclosure has been described in detail, the present disclosure is not to be limited to the aforementioned individual embodiments. These embodiments are capable of various additions, substitutions, changes, partial omissions, etc., in a scope not departing from the gist of the present disclosure, or a scope not departing from the spirit of the present disclosure derived from the contents recited in the claims and their equivalents. In addition, these embodiments can be implemented by combining. For example, in the aforementioned embodiments, the order of each operation and the order of each process are shown as examples, and are not to be limited thereto. In addition, cases in which the numerical values or formulas are being used in the description of the aforementioned embodiments are similar.

The following notes are further disclosed with respect to the above-described embodiments and modifications.

### Supplementary Note 1

A numerical control system for controlling a robot via a robot control device based on machining programs of a numerical control device, the numerical control system including: a variable list information generator that acquires variables from within all of the machining programs in the numerical control device, and generates variable list information in which the variables and the machining programs are associated; and a program editor that, in a case of a variable of the variables included in the machining program of the numerical control device or the robot program of the robot control device being used in a corresponding relationship different from those in the variable list information, does not use the variable, and, in a case of the variables included in the variable list information being used by a machining program which is not present in the variable list information, does not use the variables.

### Supplementary Note 2

In the numerical control system as described in Supplementary Note 1, the variable list information generator acquires the variables from within all of the robot programs of the robot control device, and adds an association between the variable and the robot program to the variable list information, and
wherein, in a case of the variables included in the variable list information being used by the robot program which is not present in the variable list information, the program editor does not use the variables.

### Supplementary Note 3

In the numerical control system as described in Supplementary Note 1 or 2, a matter of not using the variables includes at least one selected from inhibiting saving of the variables, inhibiting referencing of the variables, and inhibiting execution of the machining programs or the robot programs including the variables.

### Supplementary Note 4

The numerical control system as described in Supplementary Note 1 or 2, further includes a display that, in a case of the variables not being used, displays a warning message indicating that the variables are not used.

### Supplementary Note 5

A numerical control system for controlling a robot via a robot control device based on a machining program of a numerical control device, the numerical control system including: a variable list information generator that acquires variables from within all of the machining programs in the numerical control device, and generates variable list information in which the variables and the machining programs are associated; and a variable list information outputter that outputs the variable list information to an output device.

### Supplementary Note 6

In the numerical control system as described in Supplementary Note 5, the variable list information generator acquires the variables from within all of the robot programs of the robot control device, and adds an association between the variables and the robot programs to the variable list information.

### Supplementary Note 7

The numerical control system as described in Supplementary Note 6, further includes a display that displays an association between the variables and the machining programs or the robot programs based on the variable list information.

### Supplementary Note 8

A numerical control device for controlling a robot via a robot control device using a machining program, the numerical control device including: a variable list information generator that acquires a variable from within the machining program of the numerical control device or the robot program of the robot control device, and generates variable list information in which the variable and the machining program or the robot program are associated; and a program editor that, in a case of the variable included in the machining program or the robot program being used in a corresponding relationship different from that in the variable list information, does not use the variable, and in a case of the variable included in the variable list information being used by a machining program which is not present in the variable list information, does not use the variable.

### Supplementary Note 9

In the numerical control device as described in Supplementary Note 8, a matter of not using the variable includes at least one of inhibiting saving of the variable, inhibiting referencing of the variable, and inhibiting execution of the machining program or the robot program including the variable.

### Supplementary Note 10

The numerical control system as described in Supplementary Note 9, further includes a display that, in a case of the variable not being used, displays a warning message indicating that the variable is not used.

### Supplementary Note 11

An industrial device includes: a receiver that receives a machining program or a robot program from a numerical control device or a robot control device; a variable list information generator that acquires a variable from within the machining program of the numerical control device or the robot program of the robot control device, and generates variable list information in which the variable and the machining program or the robot program are associated; and a variable list information outputter that outputs the variable list information to an output device.

### Supplementary Note 12

The industrial device as described in Supplementary Note 11 further includes: a display that displays an association between the variable and the machining program or the robot program based on the variable list information.

### Supplementary Note 13

A computer program for causing a computer controlling a robot via a robot control device based on a machining program of a numerical control device to execute: a step of acquiring variables from within all of machining programs in the numerical control device, and generating variable list information in which the variables and the machining programs are associated; a step of, in a case of a variable of the variables included in the machining program of the numerical control device or the robot program of the robot control device being used in a corresponding relationship different from those in the variable list information, not using the variable,; and a step of, in a case of the variables included in the variable list information being used by a machining program which is not present in the variable list information, not using the variables.

### EXPLANATION OF REFERENCE NUMERALS

1 numerical control system
2 machine tool
3 robot
4 industrial device
5 numerical control device
6 robot control device
41 variable list information generation unit
42 variable list information output unit
43 data transmitter receiver unit
51 storage unit
52 program input unit
53 analysis unit
54 control unit
55 data transmitter receiver unit
56 input unit
57 program editing unit
58 display unit
61 storage unit
62 program input unit
63 analysis unit
64 control unit
65 data transmitter receiver unit
66 input unit
67 program editing unit
68 display unit

1. A numerical control system for controlling a robot via a robot control device based on machining programs of a numerical control device, the numerical control system comprising:
a variable list information generator that acquires variables from within all of the machining programs in the numerical control device, and generates variable list information in which the variables and the machining programs are associated; and
a program editor that, in a case of a variable of the variables included in the machining program of the numerical control device or the robot program of the robot control device being used in a corresponding relationship different from those in the variable list information, does not use the variable, and, in a case of the variables included in the variable list information being used by a machining program which is not present in the variable list information, does not use the variables.

2. The numerical control system according to claim 1, wherein the variable list information generator acquires the variables from within all of the robot programs of the robot control device, and adds an association between the variable and the robot program to the variable list information, and
wherein, in a case of the variables included in the variable list information being used by the robot program which is not present in the variable list information, the program editor does not use the variables.

3. The numerical control system according to claim 1, wherein a matter of not using the variables includes at least one selected from inhibiting saving of the variables, inhibiting referencing of the variables, and inhibiting execution of the machining programs or the robot programs including the variables.

4. The numerical control system according to claim 1, further comprising a display that, in a case of the variables not being used, displays a warning message indicating that the variables are not used.

5. A numerical control system for controlling a robot via a robot control device based on a machining program of a numerical control device, the numerical control system comprising:
a variable list information generator that acquires variables from within all of the machining programs in the numerical control device, and generates variable list information in which the variables and the machining programs are associated; and
a variable list information outputter that outputs the variable list information to an output device.

6. The numerical control system according to claim 5, wherein the variable list information generator acquires the variables from within all of the robot programs of the robot control device, and adds an association between the variables and the robot programs to the variable list information.

7. The numerical control system according to claim 6, further comprising a display that displays an association between the variables and the machining programs or the robot programs based on the variable list information.

8. A numerical control device for controlling a robot via a robot control device using a machining program, the numerical control device comprising:
a variable list information generator that acquires a variable from within the machining program of the numerical control device or the robot program of the robot control device, and generates variable list information in which the variable and the machining program or the robot program are associated; and
a program editor that, in a case of the variable included in the machining program or the robot program being used in a corresponding relationship different from that in the variable list information, does not use the variable, and in a case of the variable included in the variable list information being used by a machining program which is not present in the variable list information, does not use the variable.

9. The numerical control device according to claim 8, wherein a matter of not using the variable includes at least one of inhibiting saving of the variable, inhibiting referencing of the variable, and inhibiting execution of the machining program or the robot program including the variable.

10. A numerical control device according to claim 9, further comprising a display that, in a case of the variable not being used, displays a warning message indicating that the variable is not used.

11. An industrial device comprising:
a receiver that receives a machining program or a robot program from a numerical control device or a robot control device;
a variable list information generator that acquires a variable from within the machining program of the numerical control device or the robot program of the robot control device, and generates variable list information in which the variable and the machining program or the robot program are associated; and
a variable list information outputter that outputs the variable list information to an output device.

12. The industrial device according to claim 11, further comprising a display that displays an association between the variable and the machining program or the robot program based on the variable list information.

13. A non-transitory computer-readable storage medium storing a program that is executed by a computer that comprises a processor of a numerical control system, the numerical control system controls a robot via a robot control device based on machining programs of a numerical control device, the program being executable to cause the computer to perform operations comprising:
a step of acquiring variables from within all of machining programs in the numerical control device, and generating variable list information in which the variables and the machining programs are associated;
a step of, in a case of a variable of the variables included in the machining program of the numerical control device or the robot program of the robot control device being used in a corresponding relationship different from those in the variable list information, not using the variable,; and
a step of, in a case of the variables included in the variable list information being used by a machining program which is not present in the variable list information, not using the variables.
